(19) United States
(12) Patent Application Publication
(10) Pub. No.: US 2011/0222556 A1
(43) Pub. Date: Sep. 15, 2011

(54) METHOD CIRCUIT AND SYSTEM FOR ADAPTIVE TRANSMISSION AND RECEPTION OF VIDEO

(76) Inventors: David SHEFLER, Hod Hasharon (IL); Shay FREUNDLICH, Givat Ada (IL)

(21) Appl. No.: 12/720,695

(22) Filed: Mar. 10, 2010

(51) Int. Cl. H04J 3/22

(52) U.S. Cl. 370/465

(57) ABSTRACT

Disclosed is a method circuit and system for adaptive transmission and reception of video data. According to some embodiments, a source side transceiver may include a static frame detector adapted to detect static portions (i.e. some or all) of a frame to be transmitted. Static frame data may be removed or replaced by a marker indicating corresponding between the static data and data in a previous frame. In response to the transmission of a static frame, the source side transceiver may adjust a characteristic of a transmission circuit, option so as to reduce transmission circuit power consumption.

### FIELD OF THE INVENTION

The present invention relates generally to the field of communication. More specifically, the present invention relates to a method, circuit and system for adaptive transmission and reception of video.

### BACKGROUND

Modern communication networks are characterized by features such as high bandwidth/data-rate, complex communication protocols, various transmissions medium, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks such as cellular and other wireless networks (e.g. 2G, 3G, CDMA, WCDMA, Wi-Fi, mobile TV, digital TV, etc.) are used to supplement coverage for various devices (e.g. cell phone, wireless IP phone, wireless internet appliance, etc.) not physically connected to a fixed network connection. Wireless networks may act as complete local loop networks and may provide a complete wireless solution, where a communication device in an area may transmit and receive data from another device entirely across the wireless network.

With the proliferation of communication networks and the world's growing reliance upon them, proper performance is crucial. High data rates and stable communication parameters at low power consumption levels are highly desirable for mobile communication devices. However, degradation of signal-to-noise ratio (“SNR”) as well as Bit energy to noise ratio (“Eb/No”) and interference ratios such as Carrier to-Interference (“C/I”) ratio occur to a signal carried along a transmission medium (e.g. coax, unshielded conductor, wave guide, open air or even optical fiber or RF over fiber). This degradation and interferences may occur in TDMA, CSMA, CDMA, EVDO, WCDMA, FDMA and Wi-Fi networks respectively. Signal attenuation and its resulting SNR degradation may limit bandwidth over a transmission medium, especially when the medium is air or open space.

Radio Frequency (“RF”) based wireless communication systems ranging from cellular communication systems to satellite radio broadcasting systems are highly prevalent, and their use is consistently growing. Due to the unshielded nature of the transmission medium of wireless RF based communication systems, they are particularly prone to various phenomena, including interference signals or noise and fading signals, which tend to limit performance of such systems.

Thus, strong and stable signals are needed for the proper operation of a wireless communication device. In order to improve the power level of signals being transmitted over relatively long distances, and accordingly to augment the transmission distance and/or data rate, devices may utilize power amplifiers to boost transmission signal strength. In addition to the use of power amplifiers for the transmission of communication signals, receivers may use low noise amplifiers (“LNAs”) and variable gain amplifiers (“VGAs”) in order to boost and adjust the strength and/or amplitude of a received signal.

An additional problem with wireless RF based transmissions is that they may be characterized by a multipath channel between the transmitter antenna and the receiver antenna which introduces “fading” in the received signal power. The combination of attenuation, noise interference and “fading” is a substantial limitation for wireless network operators, mitigating their ability to provide high data-rate services such as Internet access and video phone services.

Some modern RF receivers may use various techniques and circuits implementing these techniques to compensate for phenomenon resulting from weak signal and interference. For example, amplifiers and filters are often employed to strengthen the incoming data signals. Methods amplifying and filtering received signals are well known. Additionally spatial diversity transmission/reception and processing circuits provide considerable S/N gain by employing multiple transmission and reception chains operating in concert. Although boosting S/N even in the most demanding noise environments is possible, having more robust processing techniques and using more elaborate circuits and systems consumes considerable energy.

There exists a need in the field of wireless communication for methods, circuits, devices and systems for enhancing video signal transmission and reception.

### SUMMARY OF THE INVENTION

The present invention is a method, circuit and system for wireless transmission and reception of video and/or audio data. According to some embodiments of the present invention, there is provided a video source side transceiver which may include: (1) a video source interface for receiving video data and/or associated audio data from a functionally associated source device (e.g. Set-Top Box, DVD, etc.); (2) a video data buffer for buffering received video data prior to transmission; (3) a frame status detector for determining whether a video frame is static or dynamic relative to a previous video frame, (4) one or more transmitters including at least one video transmission circuit for transmitting video data of video frames whose delta relative to a previous video frame exceeds a threshold. According to some embodiments of the present invention, instead of transmitting video data of a static frame, the video transmission circuit may transmit a control signal indicating that the non-transmitted frame was static relative to a previous (e.g. immediately previous) frame. According to further embodiments of the present invention, a transmitter controller may upon detection of a static frame condition shutdown and/or put into sleep-mode or standby-mode one or more circuits associated with the one or more transmitters.

According to further embodiments of the present invention, there may be provided a sink side transceiver which may include one or more receivers at least one of which is a video data receiver, a video frame buffer, and a buffer controller which in response to receiving a signal indicating that a non-transmitted frame (e.g. frame which was to be currently received) was static relative to a previously received frame may cause the video frame buffer to output for display as a current frame the same frame data as received for the previous frame (e.g. the last dynamic frame). According to further embodiments of the present invention, the frame buffer controller may receive a control signal indicating that the frame buffer should continue to output for display the last received frame (e.g. last dynamic frame) data until further signaling/instruction are received. According to further embodiments of the present invention, upon receiving a signal indicating a static frame condition, a receiver controller may shutdown and/or put into sleep-mode or standby-mode one or more circuits associated with the one or more receivers.

According to some embodiments of the present invention, the term static frame may refer to one or more portions of a complete frame. According to further embodiments of the present invention, video source transceiver may segment a frame into dynamic and static portions and may treat dynamic portions in a conventional manner, while treating static portions as described above. The same may apply for a sink side transceiver, which sink side transceiver may respond to dynamic frame portions in a conventional manner, while treating received static portions as described above. According to yet further embodiments of the present invention, the source side transceiver may transmit information relating to a percentage of the frame which is static, and the sink side transceiver may select to shut down or put into sleep mode portions of the receive chain if the percentage is above a threshold value, and optionally if a detected SNR is below a threshold value.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary setup showing the different elements of the system according to some embodiments of the present invention;

FIG. 2 shows an exemplary layout of a screen that may be generated by a source device and transmitted wirelessly to a display;

FIG. 3 shows an example schematic diagram of a video stream and the resulting transmitted data according to some embodiments of the present invention;

FIG. 4 shows another example schematic diagram of a video stream and the resulting transmitted data according to some other embodiments of the present invention;

FIGS. 5 & 6 show two different example schematic diagrams of video streams and the resulting transmitted data according to some other embodiments of the present invention in which the refresh rate is larger than 1; and

FIG. 7 shows an example of receiver circuits' power down according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

In wireless video transmission there may be a need to save power, especially when the video stream is transmitted from battery operated devices such as laptop computers.

According to some embodiments of the present invention, the video stream may be analyzed prior to transmission, and portions of the transmitter may be shut down or put into sleep or standby mode when the video frames have small or no changes between one another. According to some embodiments of the present invention, portions of the receiver may be shut down or put into sleep or standby mode when the video frames have small or no changes between one another.

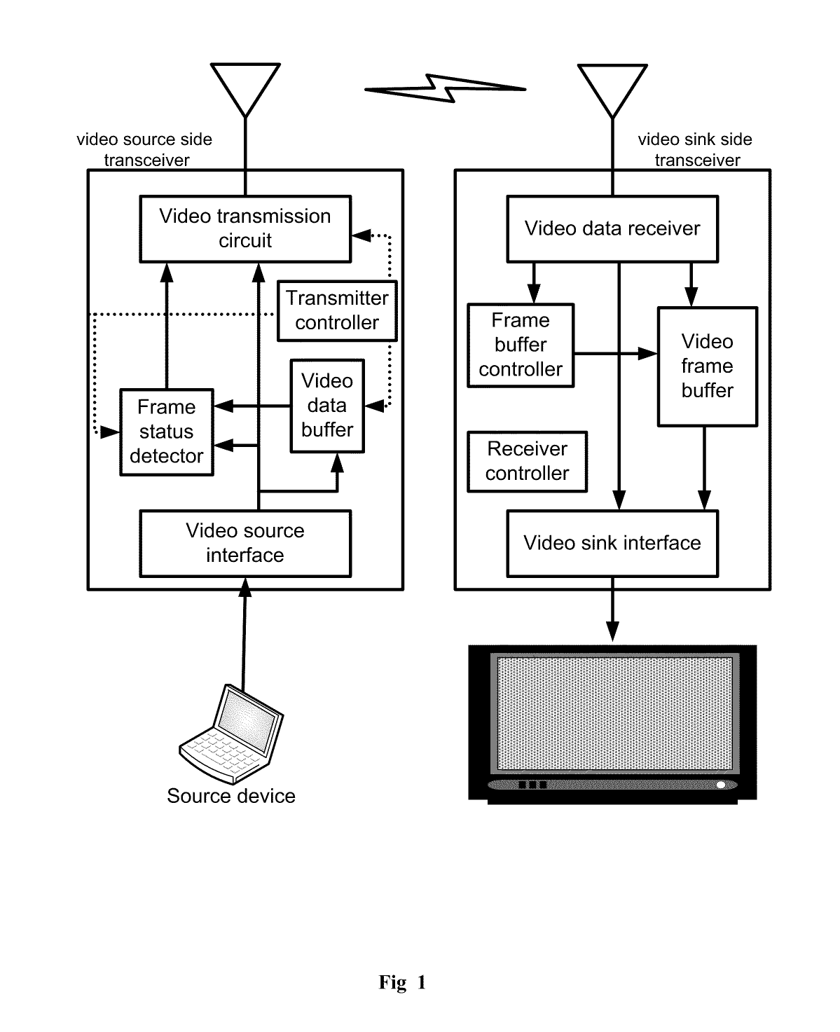

FIG. 1 shows an example of some embodiments of the present invention.

According to some embodiments of the present invention, there may be provided a wireless video source side transceiver comprising a video source interface, a video data buffer, a frame status detector, a transmitter controller, and a video transmission circuit. According to some embodiments of the present invention, the video source side transceiver may communicate wirelessly with a video sink side transceiver.

According to some embodiments of the present invention, the video source interface may be adapted to receive video and/or audio based data from a functionally associated video and/or audio source device. According to some embodiments of the present invention, the video source interface may be a “Combined interface” where the Audio and Video signals share the same leads for example, HDMI (High-Definition Multimedia Interface) or an advanced version of ‘DisplayPort’ cable or port/connector.

According to some other embodiments of the present invention the video source interface may be a “Separated interface” where the Video and Audio signals are separated (e.g. VGA, composite, DVI) cable/port/connector.

According to some embodiments of the present invention, the video source interface may be an interface to a memory which may store the video information. According to some embodiments of the present invention, the video source interface may be a general data bus such as USB, PCI, PCIe which may be connected to another part of the system.

According to some embodiments of the present invention, the video and/or audio source device may generate a video stream in which the video frames are changing rapidly such as in a movie. According to some embodiments of the present invention, the video and/or audio source device may generate a video stream in which the video frames are rarely changing such as in a PowerPoint presentation. According to some embodiments of the present invention, the source device may be a DVD, or a Set-Top-Box, or a computer, or a video camera, or a game console, or a VCR or any other device capable of generating video and/or audio signals.

According to some embodiments of the present invention, the video data buffer may be adapted to receive a video stream consisting of video frames from the video source interface and save the last one or more frames received, or a mathematical representation of the last one or more frames received. According to some embodiments of the present invention, the video data buffer may be a FIFO (First In First Out) type of memory.

According to some embodiments of the present invention, the frame status detector may be adapted to determine whether a video frame received at the source interface is substantially similar to the previous frame received, and which may have been stored in the video data buffer. According to some embodiments of the present invention, the frame status detector may receive input parameters (threshold) which may determine the conditions upon which a first frame may be considered substantially similar to a second frame. According to some embodiments of the present invention, the frame status detector may signal to an associated transmitter controller whether the current frame is substantially similar to the previous frame or not.

According to some embodiments of the present invention, the wireless video transmission circuit may be adapted to transmit a video based data signal and/or an audio based data signal and/or a control data signal. According to some embodiments of the present invention, the video transmission circuit may be comprised of one or more radio transmitters.

According to some embodiments of the present invention, the transmitter controller may be adapted to shutdown and/or put into sleep-mode or standby-mode one or more circuits associated with the one or more radio transmitters and/or with the frame status detector and/or with the video data buffer.

According to some embodiments of the present invention, there may be a wireless sink side transceiver comprising a video data receiver circuit, a video frame buffer, a frame buffer controller, a receiver controller, a video sink interface. According to further embodiments of the present invention, the video sink side transceiver may communicate wirelessly with a video source side transceiver.

According to some embodiments of the present invention, the wireless video data receiver circuit may be adapted to receive a signal comprising a video based data signal, an audio based data signal, a control data signal. According to some embodiments of the present invention, the video data receiver circuit may comprise one or more radio receivers.

According to some embodiments of the present invention, the video frame buffer may be adapted to store the last one or more received video frames, or portions of received video frames, or a mathematical representation of the last one or more frames, or portions of frames, received from the associated video data receiver circuit. According to some embodiments of the present invention, the video frame buffer may be a FIFO (First In First Out) type of memory.

According to some embodiments of the present invention, the frame buffer controller may receive control data signals from the video data receiver circuit. According to some embodiments of the present invention, the control data signals may indicate that the previous frame received and stored in the video frame buffer may be sent to the video sink interface and output for display as the current frame. According to some embodiments of the present invention, the control data signal may indicate that the previous frame received and stored in the video frame buffer may be repeatedly sent to the video sink interface and outputted for display until a new control data signal may indicate differently. According to some embodiments of the present invention, the control data signal may determine that a received portion of a frame may replace the corresponding portion of the previous frame received and stored in the video frame buffer, and may be sent to the video sink interface and output for display as the current frame. According to some embodiments of the present invention, the control data signal may determine whether the currently received frame should be stored in the video frame buffer or not.

According to some embodiments of the present invention, the receiver controller may be adapted to shutdown and/or put into sleep-mode or standby-mode one or more circuits associated with the one or more radio receivers and/or with the buffer controller and/or with the video frame buffer.

According to some embodiments of the present invention, the video sink interface may be adapted to send video and/or audio based data to a functionally associated video and/or audio sink device (e.g. LCD video screen). According to some embodiments of the present invention, the video sink interface may be a “Combined interface” where the Audio and Video signals share the same leads for example, HDMI (High-Definition Multimedia Interface) or an advanced version of ‘DisplayPort’ cable/port/connector. According to some other embodiments of the present invention the video sink interface may be a “Separated interface” where the Video and Audio signals are separated (e.g. VGA, composite, DVI) cable/port/connector.

According to some embodiments of the present invention, the video source side transceiver and the video sink side transceiver may exchange control data signals. According to further embodiments of the present invention, the control data signals may include information regarding the frame status (static or dynamic). According to some embodiments of the present invention, when just a portion of a video frame is sent from the source side transceiver to the sink side transceiver, the control data signals may include information regarding the block size and coordinates.

According to some embodiments of the present invention, there may be a source device such as a laptop computer. According to some embodiments of the present invention the source device may output a video signal to be displayed on a display connected to the source device through a wireless video link. According to some embodiments of the present invention, the video source device may output a video stream with rapidly changing frames such as a movie. According to some embodiments of the present invention, the video source device may output a video stream in which the video frames are substantially similar to one another and may change just once in a while such as for example, in a Power-Point presentation or a slide show. According to some embodiments of the present invention, the video source device may output a video stream in which the video frames may be substantially similar to one another in certain parts of the frame and may change in other parts of the frame such as for example, in a Power-Point presentation with a mouse movement, or a static computer screen with a movie window, or a static webpage with an animated banner.

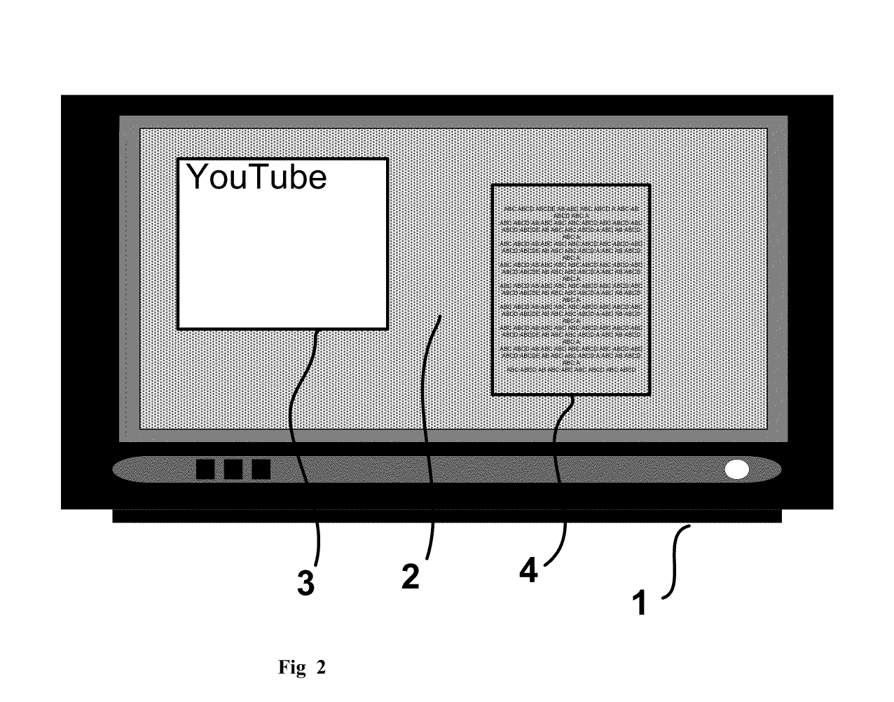

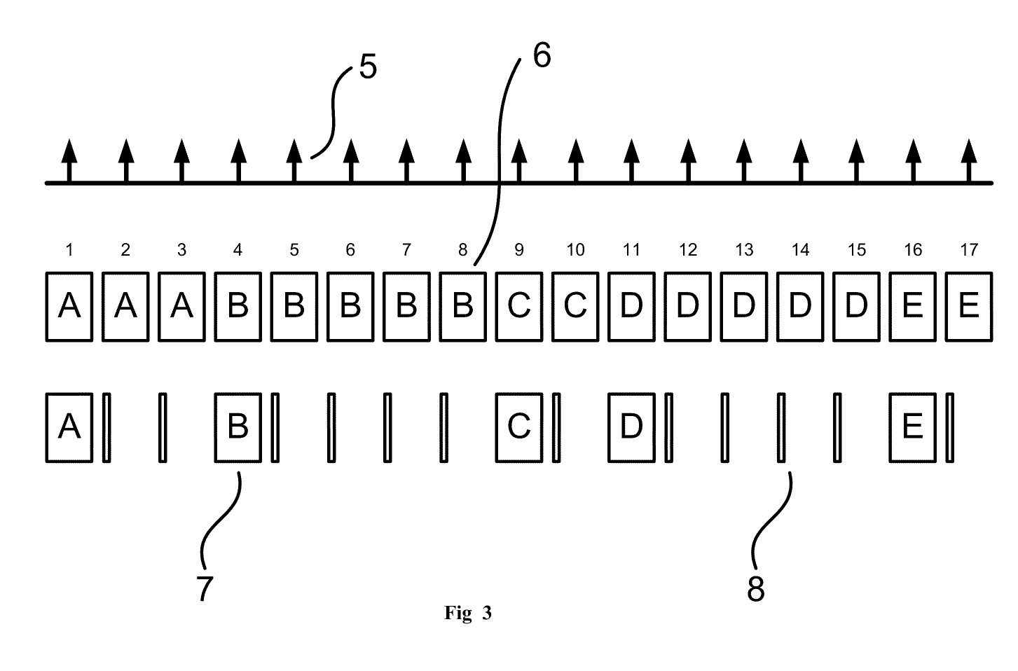

FIG. 2 is an exemplary drawing according to some embodiments of the present invention. In this example, the video stream displayed on the screen (1) may include a static background (2), a static window such as a word processor window (4), and a dynamic window such as a YouTube movie (3).

According to some embodiments of the present invention, there is provided a video source side transceiver which may include a video source interface for receiving video data and/or associated audio data from a functionally associated video source device.

According to some embodiments of the present invention, the video source side transceiver may also include a video data buffer for temporarily storing the received one or more last video frames or a mathematical representation of the one or more last video frames received from the video source interface. According to some embodiments of the present invention, the video source side transceiver may also include a frame status detector for determining 1) whether a received video frame is substantially similar to the previously received frame which may be stored in the video data buffer, or 2) whether a received video frame is substantially similar to the previously received frame which may be stored in the video data buffer in most parts of the frame, and different from the previously received frame in other parts (as shown for example in FIG. 2). According to some embodiments of the present invention, there may be configuration parameters functionally associated with the frame status detector for determining the threshold indicating that two frames may be considered substantially similar. According to some embodiments of the present invention, the configuration parameters may determine the amount of allowed noise and/or the amount of shade and/or the amount of flicker and/or the amount of shake between the currently received video frame and a previously received video frame.

According to some embodiments of the present invention, the video source side transceiver may also include a video transmission circuit for wirelessly transmitting the video data. According to some embodiments of the present invention, the video transmission circuit may comprise one or more wireless transmitters.

According to some embodiments of the present invention, upon detection by the frame status detector that the current frame received from the video source interface is not substantially similar to the previously received frame, the current frame may be sent to the video transmission circuit for transmission.

According to some embodiments of the present invention, upon detection by the frame status detector that the current frame received from the video source interface is substantially similar to a previous frame, a control data signal indicating that the current frame is static (i.e. substantially similar) may be sent to the video transmission circuit for transmission instead of the frame itself.

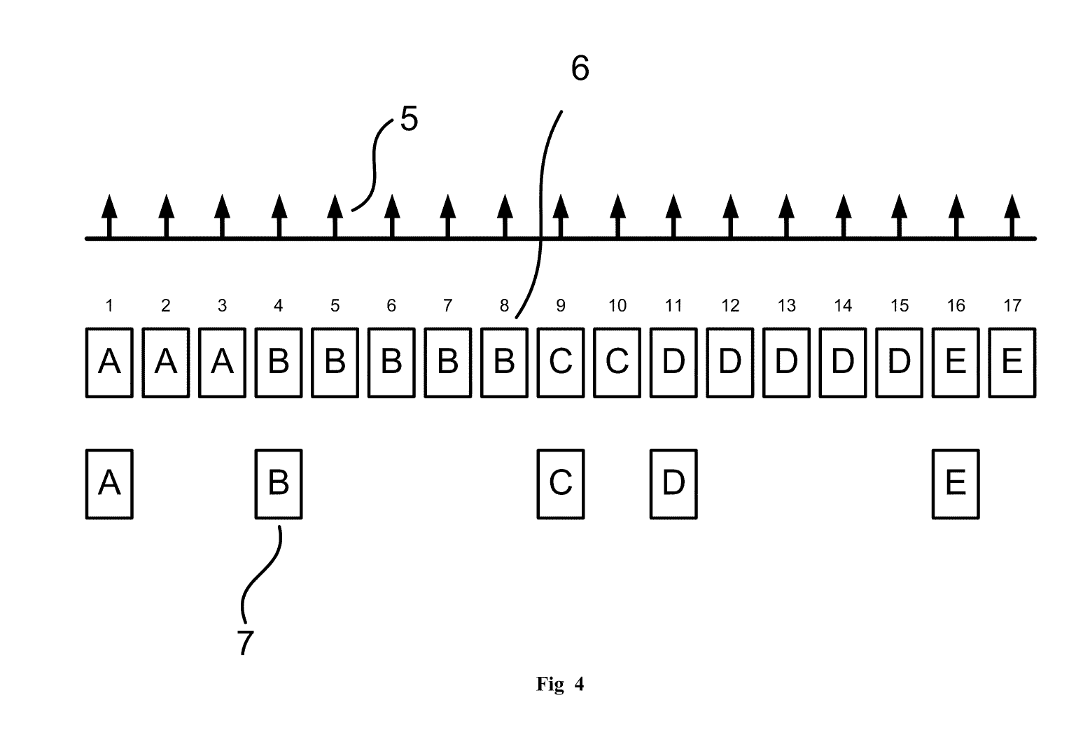

FIG. 3 shows an example of some embodiments according to the present invention. In this figure, 17 frames out of the video stream are shown (6). Frame 1 is dynamic, frames 2 and 3 are static, frame 4 is a dynamic frame, and frames 5,6,7 and 8 are static. Frame 9 is dynamic, frame 10 is static, frame 11 is dynamic. Frame 12,13,14 and 15 are static, frame 16 is dynamic, and frame 17 is static. The upright arrows (5) describe the comparison of the current frame to the previous frame by the frame status detector. When the current frame is not substantially similar to the previous frame as is the case with frames 3 and 4, the current frame may be sent to the video transmission circuit for transmission (7). When the current frame is substantially similar to the previous frame as is the case with frames 13 and 14, a data control signal may be sent to the video transmission circuit for transmission (8).

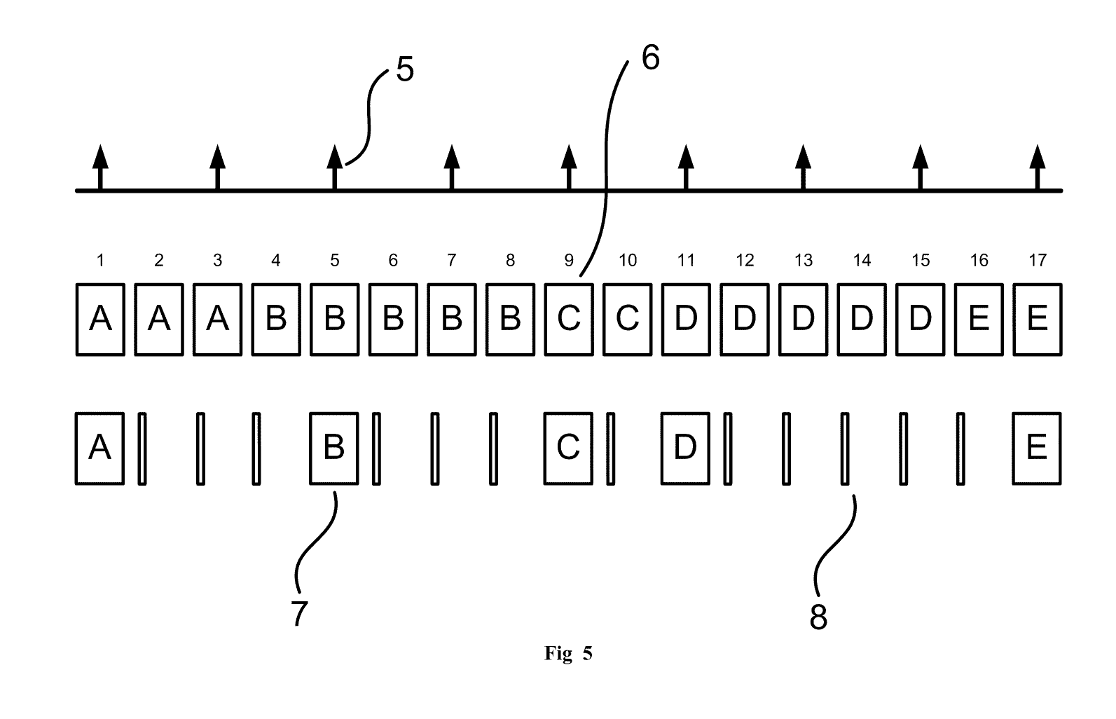

According to some other embodiments of the present invention, upon detection by the frame status detector that the current frame received from the video source interface is substantially similar to a previous frame, the currently received frame may be discarded and not sent to the video transmission circuit. FIG. 4 shows an example of some embodiments according to the present invention, similar to the example in FIG. 3. When the current frame is not substantially similar to the previous frame as is the case with frames 3 and 4, the current frame may be sent to the video transmission circuit for transmission (7). When the current frame is substantially similar to the previous frame as is the case with frames 13 and 14, the frame may be discarded.

By replacing the video data frame with a short control data signal, or by discarding the video data frame, the transmission time may be reduced significantly and hence save a significant amount of power and free up bandwidth that may be used for transmission of other information.

According to some embodiments of the present invention, upon detection by the frame status detector that the current frame received from the video source interface is substantially similar to a previous frame in some parts of the frame and not substantially similar to a previous frame in other parts of the frame, a subset of the current frame which is not substantially similar to a previous frame may be sent to the video transmission circuit along with a control data signal indicating the dimensions and coordinates of the frame subset. FIG. 2 shows an example of a frame which is partially static and partially dynamic. In the example of FIG. 2, areas 2 and 4 are static, while the YouTube movie in window 3 is dynamic. In this case only the area of window 3 may be detected by the frame status detector as dynamic and may be sent to the video transmission circuit along with a control data signal indicating the dimensions of window 3 and its coordinates within the screen 1.

By replacing the video data frame with a subset of that frame and a short control data signal, the transmission time may be reduced significantly and hence save a significant amount of power. and free up bandwidth that may be used for transmission of other information.

Since the comparison of the current video frame to a previously received video frame by the frame status detector is compute intensive and therefore consumes a large amount of power, in order to further reduce power consumption in applications such as presentations or slideshow in which video frames are most of the time static, in some embodiments of the present invention, the frame status detector may compare the currently received frame to a previous frame at a lower rate (refresh rate) than the rate frames are received at the video source interface, and at the rest of the time the frame status detector may be put into sleep or power down or standby mode.

According to some embodiments of the present invention, the video source side transceiver may be configured to operate in several modes according to the type of source device connected to it and/or according to the type of video data received by it.

According to some embodiments of the present invention, the operating mode may determine the refresh rate (e.g 60 Hertz for High Definition video, 5 Hertz for slideshow). In a highest refresh rate, the refresh period (the time (measured in frames) elapsed between the start of comparing two consecutive frames by the frame status detector to the next comparison start) may be one frame period. For example, when frames are received at a rate of 60 Hertz and the refresh rate is 5 Hertz, the refresh period is 12 frames.

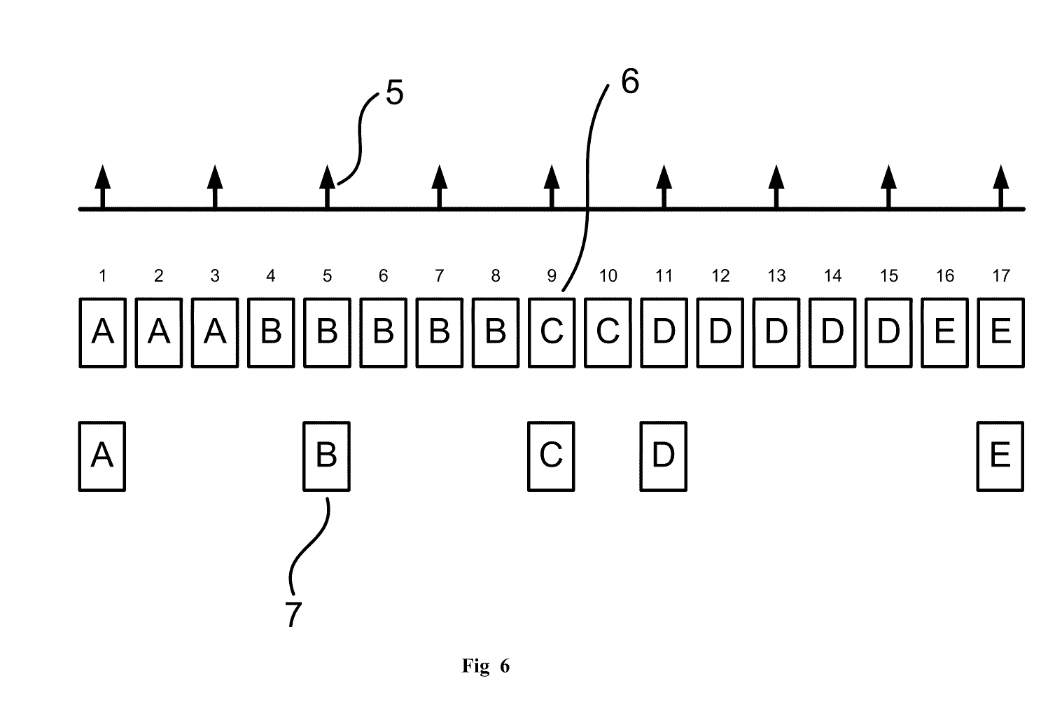

According to some embodiments of the present invention, when the video source side transceiver is configured to operate at a slower refresh rate (X) than the rate (Y) in which frames are received at the video source interface, video frames received at the video source interface may be sent to the video transmission circuit at most, at the refresh rate X, while control data signals indicating static video frames may be sent to the video transmission circuit at least at a rate of Y-X such that the total number of video frames+control signals sent to the video transmission circuit may be equal to the number of video frames received at the video source interface. FIG. 5 shows an example of some embodiments according to the present invention, similar to the example in FIG. 3 but with a lower refresh rate. In the example shown in FIG. 5, the refresh period is 2 and the frame status detector compares each second frame (5) and hence may save power.

According to some embodiments of the present invention, the transmitter controller may shut down or put into sleep or standby mode, the video data buffer and/or the frame status detector and/or any other circuit of the source side transceiver that may not be operational during a time window of a refresh period less one frame time, in each refresh period. For example, if the refresh period is 12, the frame status detector may compare the currently received frame to a previously received frame during a time of one frame period, than the video data buffer and/or the frame status detector and/or any other circuit may shut down or put into sleep or standby mode for a time period of 11 frames which will save 11/12 (92%) of the power consumption drawn by the frame status detector and/or other circuits of the source side transceiver.

According to some embodiments of the present invention, when the video source side transceiver is configured to operate at a slower refresh rate than the rate in which frames are received at the video source interface, the frame status detector may compare each refresh period, the frame that was currently received at the video source interface with a previous frame that may be stored in the video data buffer and may send the currently received frame to the video transmission circuit only if the current frame is not substantially similar to a previous frame.

FIG. 6 shows an example of some embodiments according to the present invention. In the example of FIG. 6 the refresh period is 2 and the frame status detector may compares (5) each odd frame with a previously received frame and may send to the video transmission circuit only the frames (7) that are not substantially similar to a previous frame.

According to some embodiments of the present invention, the frame status detector may compare a frame that was currently received at the video source interface, and the frame that was received at the video source interface immediately before the current frame.

According to some embodiments of the present invention, the frame status detector may compare a frame that was currently received at the video source interface, and the frame that was received at the video source interface one refresh period before the current frame.

In the examples shown in FIG. 5 and FIG. 6, the frame status detector may compare frames 3,5,7,9,11,13,15,17 to frames 1,3,5,7,9,11,13,15 respectively.

In applications such as movies played by a DVD where the majority of the frames are dynamic, it may be better, in order to save the power consumption of the frame status detector, not to compare the current video frame to a previously received video frame.

According to some embodiments of the present invention, when the video source side transceiver is configured to operate in dynamic mode, the transmitter controller may shut down or put into sleep or standby mode, the video data buffer and/or the frame status detector.

According to some embodiments of the present invention, the operating mode of the video source side transceiver may be configured by the user.

According to some embodiments of the present invention, the operating mode of the source side transceiver may be determined automatically.

According to some embodiments of the present invention, automatically determining the operating mode of the source side transceiver may comprise the following steps:
1) The source side transceiver may operate in dynamic mode in which every frame received at the video source interface may be sent to the video transmission circuit, and also stored in the video data buffer. The frame status detector may compare the frames received at the video source interface with a previously received frame stored in the video data buffer in order to determine if the current frame is static (i.e. substantially similar to a previous frame), or partially static (i.e. part of the current frame is substantially similar to the corresponding part of a previous frame), or dynamic (i.e. the entire current frame is not substantially similar to a previous frame). The frame status detector may send the comparison results to the transmitter controller.
2) The transmitter controller may configure a new operating mode upon analyzing the comparison results received from the frame status detector. For example: In a slideshow frames may change once every few seconds, therefore all frames may be detected as static except for one frame every few seconds which may be detected as dynamic. In this case, the transmitter controller may set the operating mode to slow refresh rate such as 5 Hertz. If for instance the slideshow will end and a movie will start, the transmitter controller may receive signals from the frame status detector that all, or near all frames are dynamic and as a result may configure the source side transceiver to operate in dynamic mode.

According to some embodiments of the present invention, a control signal may be sent to the video transmission circuit instead of each static frame.

According to some embodiments of the present invention, a control signal may be sent to the video transmission circuit only instead of the first static frame.

According to some embodiments of the present invention, a control signal may be sent to the video transmission circuit every certain number of consecutive static frames.

According to some embodiments of the present invention, the transmitter controller may put the video transmission circuit into power down or sleep or standby mode during the time in between control frames or in between a control frame to a dynamic frame.

According to some embodiments of the present invention, there is provided a sink side transceiver which may include one or more receivers at least one of which is a video data receiver. According to some embodiments of the present invention, at least two of the receivers may be video data receivers operating in a MIMO scheme. According to some embodiments of the present invention, the video sink side transceiver may also include a frame data buffer for temporarily storing the received one or more last video frames received at the one or more video receivers. According to some embodiments of the present invention, video frames received at the one or more video receivers may be output for display. According to some embodiments of the present invention, the video sink side transceiver may also include a frame buffer controller. According to some embodiments of the present invention, upon not receiving a video frame at the video frame receiver the frame buffer controller may output for display the last video frame that was received and stored in the frame data buffer. According to some embodiments of the present invention, the video sink side transceiver may also include a receiver controller. According to some embodiments of the present invention, upon receiving a control signal, the receiver controller may shutdown and/or put into sleep-mode or standby-mode one or more circuits associated with the one or more receivers, for the duration of one or more video frame(s).

When operating at a slow refresh rate (i.e refresh period larger than 1), there may be a quiet interval of at least one or more frames from the time one frame has been transmitted and until the next frame may be transmitted, this quiet time interval may enable to turn off or shutdown and/or put into sleep-mode or standby-mode one or more circuits associated with the one or more MIMO receivers, this may degrade the reception quality but the quiet time interval in between the transmitted frames may be used for enabling retransmissions and guaranteeing proper frame reception, or for other transmissions (e.g. Wi-Fi data network).

According to some embodiments of the present invention, when the sink side transceiver has two or more MIMO receivers and when operating in a slow refresh rate mode, the receiver controller may turn off or shutdown and/or put into sleep-mode or standby-mode one or more circuits associated with the one or more MIMO receivers. According to some embodiments of the present invention, when the sink side transceiver has two or more MIMO receivers and when operating in a slow refresh rate mode with one or more circuits associated with the one or more receivers shutdown and/or in sleep-mode or standby-mode, upon detection by the receiver controller that the rate of retransmissions exceeded a certain threshold, the receiver controller may turn back on one or more circuits associated with the one or more receivers. According to some embodiments of the present invention, upon receiving a control signal indicating a static frame condition, the receiver controller may shutdown and/or put into sleep-mode or standby-mode one or more circuits associated with the one or more receivers

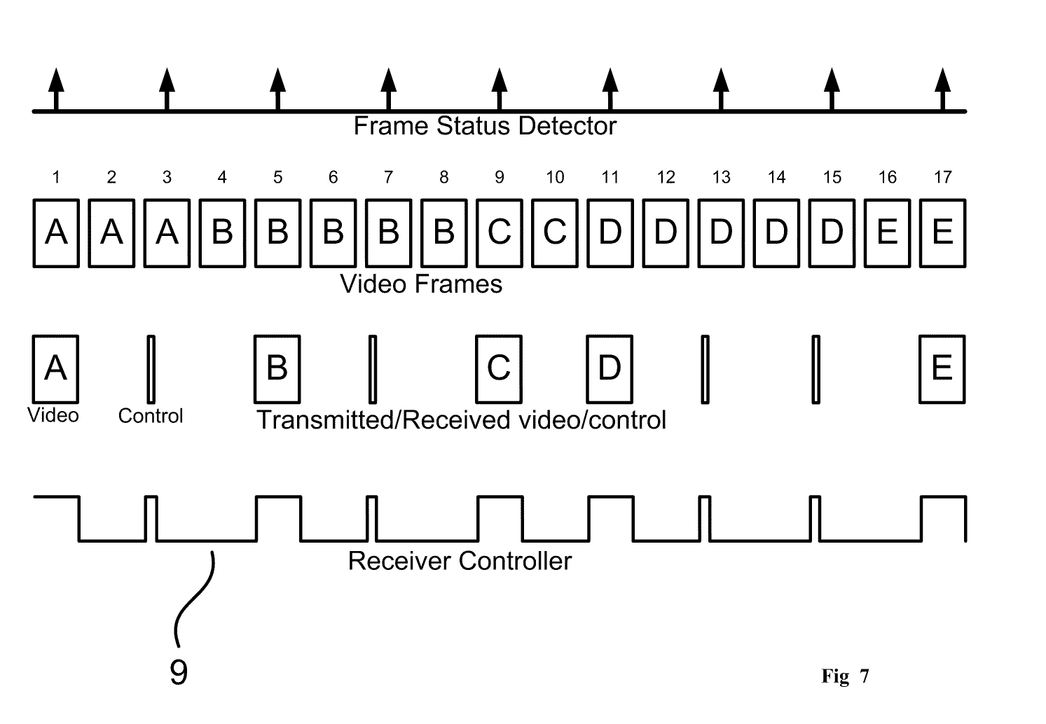

FIG. 7 shows an example of some embodiments of the present invention. In the example shown in FIG. 7 the refresh rate is 2. Line 9 represents the output of the receiver controller, when high, one or more circuits associated with the one or more video data receivers may be on, when low, one or more circuits associated with the one or more video data receivers may be put into shutdown and/or into sleep-mode or standby-mode. As shown in this example, one or more video data receivers may be on for receiving frame 1, after which they may be turned off (or put into sleep or standby mode) until the time when frame 3 is about to be received in which they are turned on again. Since frame 3 does not arrive and a control data signal is received instead, the one or more video receivers may be turned off as soon as the control data signal ends until the time when frame 5 is about to be received.

According to some embodiments of the present invention, power mode and/or current consumption settings may differ across different standards according to the required SNR for substantially clear reception and bandwidth, the RF tuner in use or any filters in use, or any other reasonable consideration.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A video source side transceiver comprising:
a frame status detector adapted to detect whether at least a portion of
a frame to be transmitter is substantially static relative to a previous frame.

2. The transceiver according to claim 1, further comprising a transceiver controller adapted to adjust a transmission circuit characteristic for transmission of a given frame upon said frame status detector indicating that at least a portion of the given frame is static.

3. The transceiver according to claim 2, wherein said controller is adapted to adjust a transmission circuit characteristic which results in a reduction of power consumption by said transmission circuit.

4. The transceiver according to claim 3, wherein said controller is adapted to adjust a transmission circuit characteristic upon said detector detecting that the static portion of the frame is greater than a threshold portion or percentage of the complete frame.

5. The transceiver according to claim 1, further comprising a transceiver controller adapted to replace remove or replace static portions of a frame.

6. The transceiver according to claim 5, wherein a static portion of a frame is replaced by a marker indicating to which portion of the previous frame the replaced portion corresponds.

7. The transceiver according to claim 6, wherein the marker indicates border pixel number or coordinates.

8. The transceiver according to claim 1, further comprising a transceiver controller adapted to signal a functionally associated sink side transceiver that a frame to be transmitted includes static portions.

9. The transceiver according to claim 8, wherein said transceiver controller is adapted to transmit to the functionally associated sink side transceiver an indicator indicating what portion or what percentage of the complete frame is static.

10. A sink side transceiver comprising:
a transceiver controller adapted to switch between conventional frame reception mode and static frame reception mode.

11. The transceiver according to claim 10, wherein said controller is adjust a reception circuit characteristic for reception of a given frame upon determining that at least a portion of the given frame is static.

12. The transceiver according to claim 11, wherein said controller is adapted to adjust a reception circuit characteristic which results in a reduction of power consumption by said reception circuit.

13. The transceiver according to claim 12, wherein said controller is adapted to adjust a reception circuit characteristic upon determining that the static portion of the frame is greater than a threshold portion or percentage of the complete frame.

14. The transceiver according to claim 10, further comprising a frame buffer and a controller, wherein said controller is adapted to augment static portions of a received frame with data from the frame buffer.

15. The transceiver according to claim 10, further comprising a frame buffer and a controller, wherein said controller is adapted to augment portions of the frame buffer with corresponding dynamic portions of a received frame.

16. A video transmission system comprising:
a source side transceiver including a static frame detector, wherein said source side transceiver is adapted to substantially suppress transmission of static portions of a current frame;
a sink side transceivers including a frame buffer and image processing logic, wherein said image processing logic is adapted generate a complete frame using previous frame data in the buffer and dynamic frame data received for the current frame.

17. The system according to claim 16, wherein said source side transceiver is adapted to adjust a transmission circuit characteristic upon detection of a static portion of a frame to be transmitted.

18. The system according to claim 16, wherein said sink side transceiver is adapted to adjust a reception circuit characteristic upon determining that a frame to be received includes a static portion.
